(19) United States
(12) Patent Application Publication
(10) Pub. No.: US 2012/0204791 A1
(43) Pub. Date: Aug. 16, 2012

(54) APPARATUS FOR TRANSPORTING STRIP-LIKE MATERIAL

(75) Inventors: Harald Gross, Langebrueck (DE); Carsten Deus, Dresden (DE); Falk Otto, Dresden (DE); Lutz Gottsmann, Grossroehrsdorf (DE); Manfred Kammer, Dresden (DE)

(73) Assignee: VON ARDENNE ANLAGENTECHNIK GMBH, Dresden (DE)

(21) Appl. No.: 13/391,423

(22) PCT Filed: Sep. 7, 2010
(86) PCT No.: PCT/EP10/63127

§ 371 Date: May 3, 2012

(30) Foreign Application Priority Data
Sep. 7, 2009 (DE) 10 2009 040 237.3
Sep. 7, 2009 (DE) 10 2009 040 238.1
Dec. 22, 2009 (DE) 10 2009 060 413.8

(51) Int. Cl. B05C 13/00; B65H 20/02

(52) U.S. Cl. 118/500; 226/168; 226/190

(57) ABSTRACT

An apparatus for transporting strip-like material, has a treatment roller and at least one transporting or strip-gliding roller. The at least one transporting or strip-guiding roller is arranged upstream or downstream of the treatment roller, and comprises a twisting roller having an axis of rotation which encloses an angle other than 0° in relation to an axis of rotation of the treatment roller. The twisting roller rotates the course taken by the strip-like material in relation to the course defined by the surface of the treatment roller.

The invention relates to an apparatus for transporting strip-like material, which has a treatment roll at least one transporting or strip-guiding roller.

Strip-like material has to be transported in many areas of technology. In such cases, the strip-like material is usually wound from an unwinding roll onto a winding-up roll over a plurality of transporting rollers and treatment rolls. It is also possible that after passing transporting rollers and treatment rolls the strip-like material is immediately subjected to a further treatment, for example is cut and further treated in sheet form.

It is known in this case that the strip-like material is subjected on one side to a treatment, for example provided with a layer. The side that is, or is to be, treated is to be denoted below as the fair side.

It is known to provide strip-like material in vacuum-coating systems with a layer on the fair side. In this case, the strip-like material is guided as coating substrate over the surface of the treatment roll, which can also be designed at the same time as a heating or cooling roll. A coating source is arranged in a fashion assigned to the treatment roll and, under defined process conditions, generates from a coating material vapor that is then deposited as a layer on the fair side of the coating substrate.

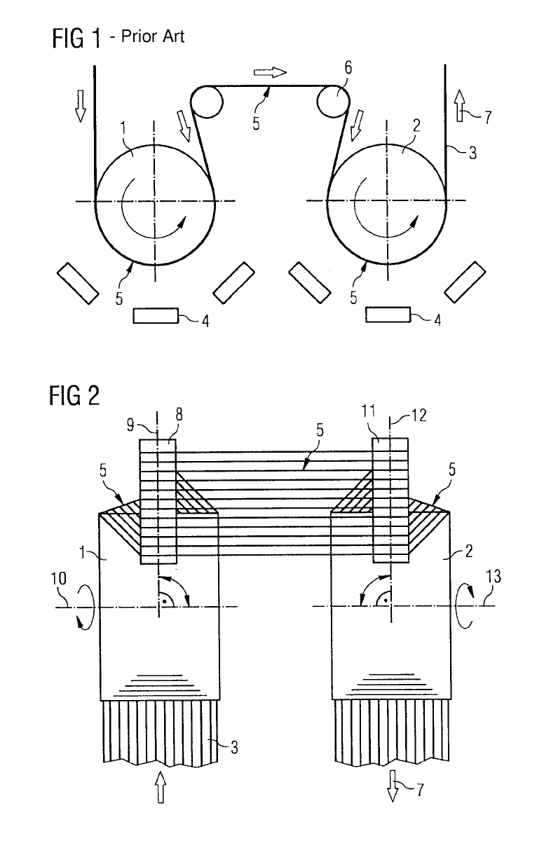

A strip guidance of this type is illustrated in FIG. 1. A first treatment roll 1 is arranged running in the same direction as a second treatment roll 2, that is to say with the same direction of rotation. The two treatment rolls 1 and 2 are partially wrapped around by a strip-like material 3. In a coating system, the strip-like material constitutes a substrate on which a layer is deposited. For this purpose, coating sources 4 are arranged opposite the treatment rolls 1 and 2, which provide the substrate 3 with a layer on its fair side 5.

Transporting or strip-guiding rollers 6 are provided in order to achieve the greatest possible wrap-around of the treatment rolls 1 and 2. The strip-like material 3 is then guided with its fair side 5 over these transporting or strip-guiding rollers 6.

Such a coating method is applied, for example, in order to deposit organic substances on the strip-like substrate. Continuous systems for depositing organic substances on strip-like substrates can have a large cost advantage, particularly in the mass production of organic semiconductors from so-called small molecules for application in luminaires or in photovoltaics. It is required in this case to avoid touching of the fair side—that is say, touching of the substrate side on which the organic layers are deposited—as far as the encapsulation of the finished component.

A multiplicity of cooling or heating rolls with a diameter of, for example, 2 m are required in order to be able to vapor deposit a plurality of organic layers one above another in a vacuum chamber, including doing so at different substrate temperatures if required.

If the aim in this case is to satisfy the condition of avoiding touching of the fair side, it is impossible to use an arrangement in accordance with FIG. 1. When the size and number of the required coating sources or the required temperature guidance of the substrate requires the strip to be guided over more than one treatment roll, it is necessary according to the prior art to select arrangements of the treatment rolls in the case of which the strip-like material is deflected in the same sense of rotation with each touching of a roll, as a result of which the degrees of design freedom for the placement of the rolls are substantially restricted and a compact and modular design of the strip guidance is rendered more difficult. There is a consequent rise in the volume of such strip guides, and so such vacuum coating systems are associated with high costs.

WO 2009/094622 A2 discloses a coating arrangement with which it is possible to avoid touching of the fair side. However, no treatment roll is provided here. Rather, the coating of the substrate is performed on an exposed planar part thereof inside a coating system. However, the treatment roll has, inter alia, a significant cooling function for the substrate that is important, in particular, in the coating of organic material.

The object of the invention is now to specify an apparatus for transporting strip-like material in the case of which touching of the fair side is avoided, and cost-effective use of which is possible in coating systems.

This object is achieved according to the invention by virtue of the fact that at least one transporting or strip-guiding roller arranged upstream or downstream of a treatment roll is designed as a twisting roller such that it has a rotation axis that encloses an angle other than 0° relative to the rotation axis respective treatment roll. The function of the twisting roller consists in rotating the strip run of the strip-like material relative to the strip run determined by the surface of the treatment roll. Such a rotation, from which the term “twisting roller” comes, can be used to ensure that the strip-like material bears with its reverse side, which lies opposite the fair side, against the twisting roller because of a rotation. In particular, with its middle fiber the strip-like material leaves the plane previously defined by this fiber. It can be transported according to the invention in spatial directions that were not accessible according to the prior art given strip guidance over axially parallel rolls.

The rotation can be continued by a plurality of twisting rollers that lie in front of or behind one another and likewise all enclose an angle other than 0° relative to the rotation axis of the previous and/or subsequent twisting roller(s). In this case, it is also possible to arrange between these twisting rollers guide rollers that lie parallel to the previous or subsequent twisting roller.

The diameters, and therefore the rotational speed of the twisting rollers and/or of the treatment rolls can be the same or different in this case.

Various system layouts with a plurality of treatment rolls without touching of the fair side by the rolls can be implemented by the strip guidance over the twisting rollers, for example an arrangement of the treatment rolls along a common rotation axis (a pair of two twisting rollers then produces a lateral offset of the strip by the spacing of the processing rolls on the common rotation axis). However, it is also possible to implement other advantageous roll arrangements such as are illustrated below. The strip run layouts possible on the basis of the twisting enable a substantially more compact and therefore more cost-effective design in comparison with conventional systems.

The invention is to be explained in more detail below with the aid of drawings, in which:

FIG. 1 shows an illustration of a known strip guidance according to the prior art,

FIG. 2 shows an illustration of an inventive strip-guiding apparatus having two coaxial treatment rolls running in opposite directions,

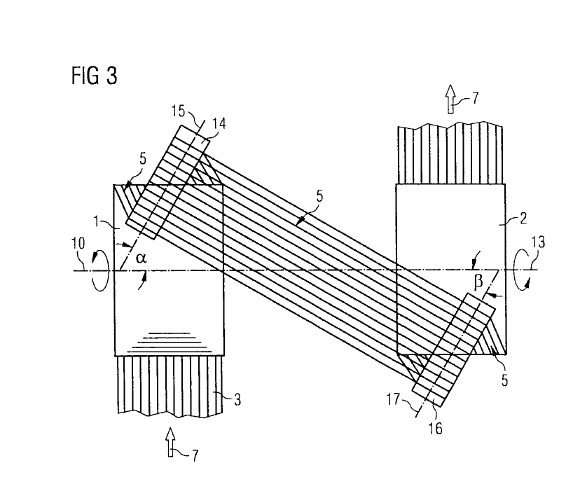

FIG. 3 shows an illustration of an inventive strip-guiding apparatus having two coaxial treatment rolls running in the same direction,

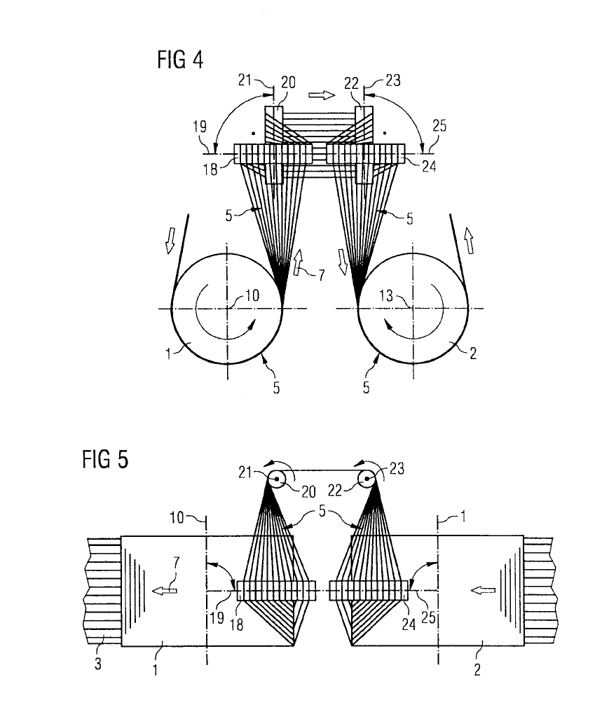

FIG. 4 shows a schematic front view of an inventive strip-guiding apparatus having two treatment rolls lying next to one another,

FIG. 5 shows a plan view of a strip-guiding apparatus according to FIG. 4,

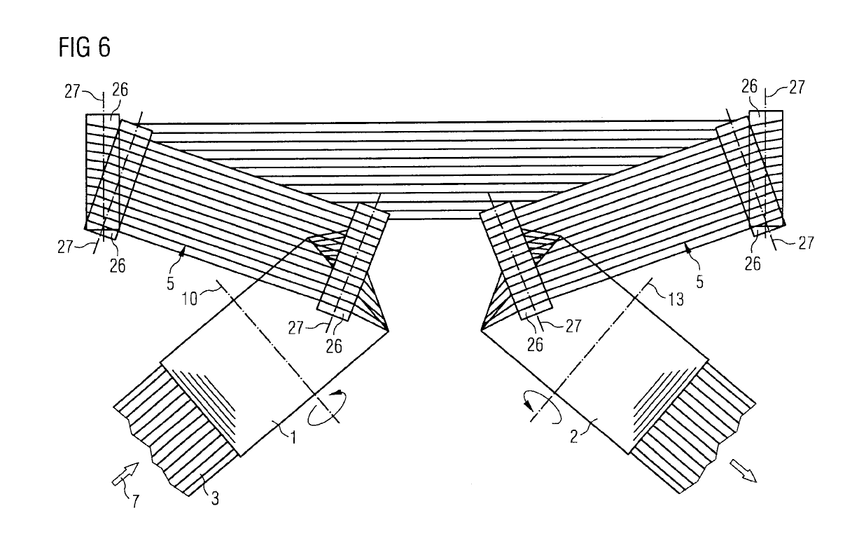

FIG. 6 shows an inventive strip-guiding apparatus having two treatment rolls arranged at an angle to one another,

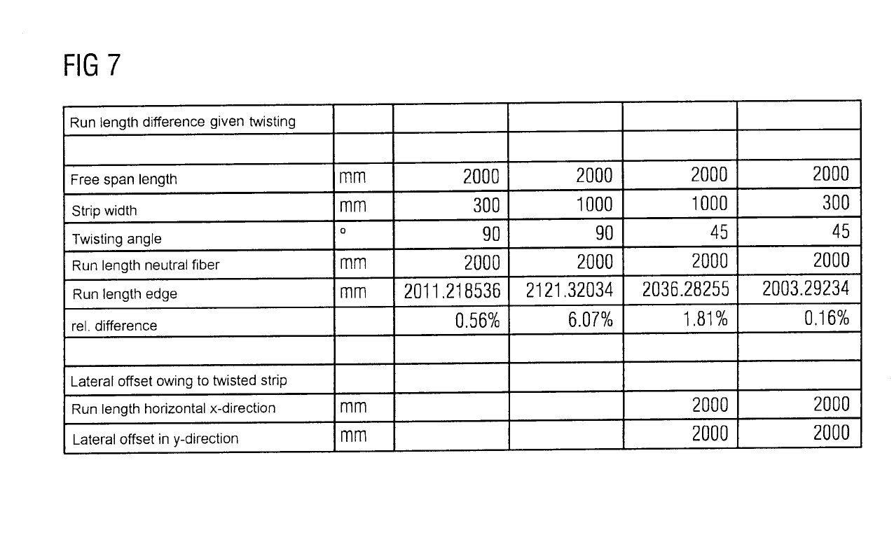

FIG. 7 shows a table for estimating the run length difference during rotation, and

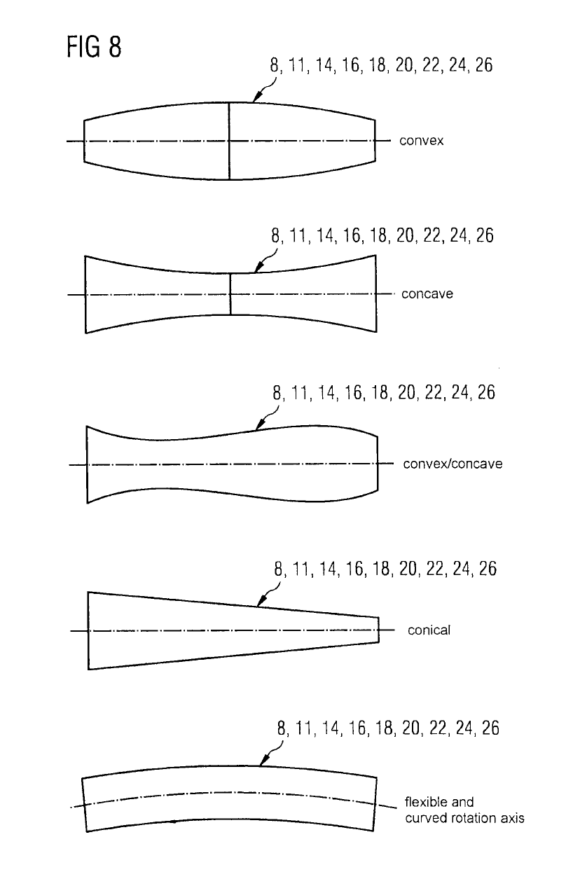

FIG. 8 shows various forms of twisting rollers.

Elements that have the same functions in the various embodiments described below as in the prior art are denoted by the same reference symbols as in FIG. 1.

If the arrangements presented are used in a coating system, the strip-like material 3 constitutes a substrate on which a layer is deposited. For this purpose, by analogy with FIG. 1, coating sources 4 are arranged opposite the treatment rolls 1 and 2, which provide the substrate 3 with a layer on its fair side 5.

In such a coating system, the treatment rolls 1 or 2 can be designed, in particular, as coating rolls, cooling or heating rolls. They can also be denoted as processing rolls. They can have rotational speeds and/or diameters that are the same or different.

It is expedient in this case for the strip-like material 3 to touch large parts of the surface of the treatment rolls 1 or 2. For this reason, transporting or strip-guiding rollers 6 are inserted upstream of, between and/or downstream of the treatment rolls 1 or 2 when seen in the strip-running direction 7. Said rollers can also have the function of a deflecting roller. As illustrated in FIG. 1, the strip-guiding rolls are axially parallel to the treatment rolls 1 and 2. In this case, the transporting or strip-guiding rollers 6 touch the strip-like material 3 on its fair side 5. This is avoided by the invention, in which the transporting or strip-guiding rollers 6 are designed as twisting rollers, as is illustrated below.

A first embodiment of an inventive arrangement is illustrated in FIG. 2. The first treatment roll 1 is arranged relative to the second treatment roll 2, that is to say on a common central axis. The two treatment rolls 1 and 2 run in opposite directions, that is to say have an opposing sense of rotation, and are partially wrapped around by the strip-like material 3.

In the strip-running direction 7 downstream of the first treatment roll 1, a twisting roller 8 is arranged such that it has a rotation axis 9 that encloses an angle of 90° relative to the rotation axis 10 of the first treatment roll 1, or in other words the perpendicular projections of the rotation axes 9, 10 enclose an angle of 90°.

Arranged in the strip-running direction downstream of the twisting roller 8 but upstream of the second treatment roll 2 is a twisting roller 11 whose rotation axis 12 is parallel to the rotation axis 9, but which likewise encloses an angle of 90° relative to the rotation axis 13 of the second treatment roll 2. As is to be gathered from FIG. 2, it is thereby possible to implement an arrangement of the treatment rolls 1 and 2 along a common central axis, a pair of twisting rollers 8 and 11 then producing a lateral offset of the strip by the spacing of the processing rolls on the common rotation axis.

A second embodiment of an inventive arrangement is illustrated in FIG. 3. The first treatment roll 1 is arranged relative to the second treatment roll 2, that is to say on a common central axis. The two treatment rolls 1 and 2 run in the same direction, that is to say have the same sense of rotation, and are partially wrapped around by the strip-like material 3. However, as already mentioned, they can have different rotational speeds and/or diameters.

In the strip-running direction 7 downstream of the first treatment roll 1, a twisting roller 14 is arranged such that it has a rotation axis 15 that encloses an acute angle a, that is to say approximately 30° to 60° depending on the distance of the treatment rolls 1 and 2, relative to the rotation axis 10 of the first treatment roll 1 or in other words the perpendicular projections of the rotation axes 15 and 10 enclose such an acute angle α.

Arranged in the strip-running direction downstream of the twisting roller 14 but upstream of the second treatment roll 2 is a twisting roller 16 whose rotation axis 17 is parallel to the rotation axis 15, but which likewise encloses an acute angle β, of approximately 30° to 60°, relative to the rotation axis 13 of the second treatment roll 2. As is to be gathered from FIG. 3, it is thereby possible to implement an arrangement of the treatment rolls 1 and 2 along a common central axis, a pair of twisting rollers 14 and 16 then producing a lateral offset of the strip by the spacing of the processing rolls on the common rotation axis.

A third embodiment of an inventive arrangement is illustrated in FIG. 4 and FIG. 5. The first treatment roll 1 and the second treatment roll 2 lie on parallel central axes and are the same concerning this as the illustration of FIG. 1. The two treatment rolls 1 and 2 run in the same direction, that is to say have the same sense of rotation, and are partially wrapped around by the strip-like material 3.

In the strip-running direction 7 downstream of the first treatment roll 1, a twisting roller 18 is arranged such that it has a rotation axis 19 that encloses a right angle with the rotation axis 10 of the first treatment roll 1, or in other words the rotation axes 19 and 10 in the projection illustrated in FIG. 5 enclose such an angle.

Arranged downstream of the twisting roller 18 in the strip-running direction is a twisting roller 20 whose rotation axis 21 encloses a right angle with the rotation axis 19 in the projection illustrated in FIG. 4. Arranged downstream of the twisting roller 20 in the strip-running direction 7 is a twisting roller 22 whose rotation axis 23 lies parallel to the rotation axis 21, but encloses a right angle with a rotation axis 25 of a subsequent further twisting roller 24 in the projection illustrated in FIG. 4, the twisting roller 24 being arranged upstream of the second treatment roll 2, and its rotation axis 25 lying parallel to the rotation axis 15 which, however, likewise encloses a right angle with the rotation axis 13 of the second treatment roll 2 in the projection illustrated in FIG. 5.

FIG. 6 shows that different angular assignments of the treatment rolls 1 and 2 are also enabled with a plurality of twisting rollers 26 whose rotation axes 1 respectively enclose angles other than 0° with one another and with the treatment rolls 1 and 2, in particular angles of more than 10°. The more twisting rollers 26 that are used, the less is the mechanical loading of the strip-like material 3 as a consequence of the twisting.

In the table illustrated in FIG. 7, calculations are carried out which indicate the run length difference between the center of the strip and edge of the strip of the strip-like material 3 as a consequence of the twisting. The run length difference is additionally varied by temperature gradients in the strip or between the treatment rolls 1 and 2 and the twisting rollers. It is now possible to design geometrical traps in the case of which the run length differences become too large such that said differences cannot be compensated by a different longitudinal expansion of the strip-like material without damaging the edges of the strip by the expansion. In such a case, undesired folding could also occur in addition to damage by overexpansion. In order to avoid this, the twisting rollers can take the form of spreader rollers (banana rollers=rubber rollers with curved axes), or generally of flexible rollers with curved axes.

Depending on the twisting angle and temperature gradients, it is, however, also possible to make interesting use of other forms of the twisting rollers, and these are illustrated in FIG. 8.

It is thereby possible to compensate the run length differences that arise between the central fiber and edge of the strip, and/or to counteract the formation of folds.

### List of Reference Symbols

1 First treatment roll

2 Second treatment roll

3 Strip-like material, substrate

4 Coating source

5 Fair side

6 Transporting or strip-guiding roller

7 Strip-running direction

8 Twisting roller

9 Rotation axis of the twisting roller 8

10 Rotation axis of the first treatment roll 1

11 Twisting roller

12 Rotation axis of the twisting roller 11

13 Rotation axis of the second treatment roll 2

14 Twisting roller

15 Rotation axis of the twisting roller 14

16 Twisting roller

α Angle

β Angle

17 Rotation axis of the twisting roller 16

18 Twisting roller

19 Rotation axis of the twisting roller 18

20 Twisting roller

21 Rotation axis of the twisting roller 20

22 Twisting roller

23 Rotation axis of the twisting roller 22

24 Twisting roller

25 Rotation axis of the twisting roller 24

26 Twisting roller

27 Rotation axis of the twisting roller 26

1. An apparatus for transporting strip-like material, comprising a treatment roll and at least one transporting or strip-guiding roller, wherein the at least one transporting or strip-guiding roller is arranged upstream or downstream of the treatment roll and comprises a twisting roller having a rotation axis that encloses an angle other than 0° relative to a rotation axis of the treatment roll.

2. The apparatus as claimed in claim 1, wherein said apparatus is transports the strip-like material during coating over two or more treatment rolls, the coating onto the material being performed at least partially on circumference of the treatment rolls and the strip-like material being guided between at least one pair of consecutive treatment rolls over at least one transporting or strip-guiding roller, and the at least one transporting or strip-guiding roller comprising a twisting roller that touches the material on an uncoated side, and wherein a rotation axis of the twisting roller is arranged non-parallel with an axis of rotation of at least one of the at least one pair of treatment rolls.

3. The apparatus as claimed in claim 1, wherein form of a lateral surface of the twisting roller deviates from a cylindrical form.

4. The apparatus as claimed in claim 3, wherein the form of the lateral surface of the twisting roller substantially corresponds to a deformed cylinder, with deformation being achieved by a curvature of a cylinder axis.

5. The apparatus as claimed in claim 4, wherein the twisting roller comprises a flexible roller with a curved rotation axis.
